(19) United States
(12) Patent Application Publication
(10) Pub. No.: US 2007/0133405 A1
(43) Pub. Date: Jun. 14, 2007

(54) Congestion controller for network transmissions

(75) Inventors: Todd Bowra, Redmond, WA (US); Gurpratap Virdi, Redmond, WA (US); Hui Jin, Redmond, WA (US); Jeffrey A. Davis, Redmond, WA (US); Harry S. Pyle, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/297,274

(22) Filed: Dec. 8, 2005

(51) Int. Cl. H04L 12/26; H04J 1/16

(52) U.S. Cl. 370/230; 370/235

(57) ABSTRACT

A congestion controller for a media server monitors both the buffer status of the client device as well as the network performance. The congestion controller may increase or decrease the pacing of packets transmitted over the network based on the fullness of a buffer on the client device, but may also change the bit rate of the packets based on the network performance. By monitoring both the client device status and network performance, the pacing and bit rate of the packets may be varied together to achieve an optimized throughput and maximized user experience of the media.

### BACKGROUND

Audio and video media are being distributed through packetized networks, such as through the internet as well as a home audio/video ecosystem. These networks are often shared by several devices, and the throughput of the network may change dynamically while the media is being distributed. Because the media must be played back on a time-sensitive basis, it is often buffered at the playback device to accommodate some variation in network performance.

In many networks, the performance of the network may change as different devices communicate on the network. A home media network may connect several devices, including a media server and one or more playback devices. Other computers, printers, and other devices may also use the network and may cause temporary traffic on the network. In an internet application, network disruptions or traffic along any portion of the path may cause the network throughput to vary significantly.

The use of a buffer to accommodate network fluctuations is often adequate to handle small variability, but larger swings in the network performance may cause the playback of the media to halt, skip, or otherwise negatively impact the viewing experience. For maximum enjoyment of the viewing experience, the playback generally is preferred at a high bit rate, which consumes network bandwidth, but can make the playback very sensitive to network performance. Thus, many systems are designed with a lower than optimum bit rate so that they are less sensitive to network fluctuations.

### SUMMARY

A congestion controller for a media server monitors both the buffer status of the client device as well as the network performance. The congestion controller may increase or decrease the pacing of packets transmitted over the network based on the fullness of a buffer on the client device, but may also change the bit rate of the packets based on the network performance. By monitoring both the client device status and network performance, the pacing and bit rate of the packets may be varied together to achieve an optimized throughput and maximized user experience of the media.

### BRIEF DESCRIPTION OF THE DRAWINGS

In the drawings,

FIG. 1 is a diagrammatic illustration of an embodiment showing a media server system.

FIG. 2 is a diagrammatic illustration of an embodiment showing a media server system with multiple bit rate sources.

FIG. 3 is a flowchart illustration of an embodiment showing a method for adjusting bit rate using buffer and network statistics.

FIG. 4 is a flowchart illustration of an embodiment showing a method for changing bit rate based on throughput rate of change.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

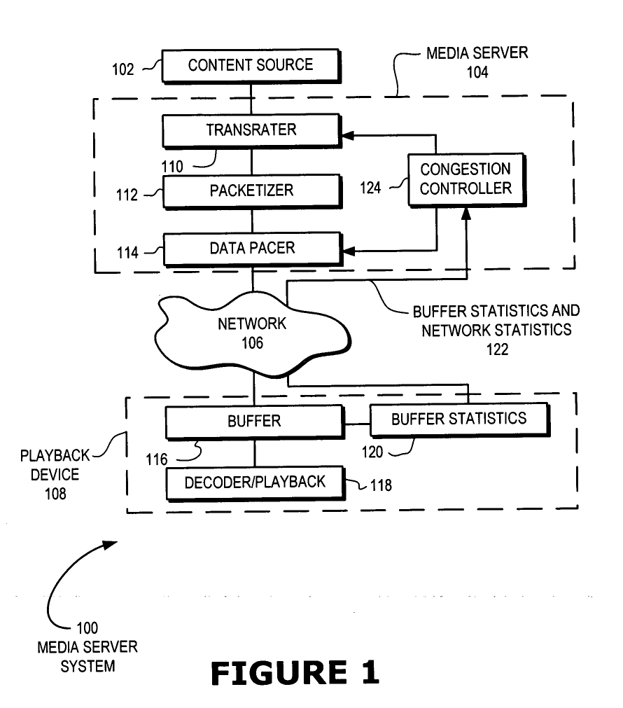

FIG. 1 is a pictorial representation of an embodiment 100 showing a media server system. A content source 102 is connected to a media server 104. The media server 104 converts the content into packetized data and transmits the data through a network 106 to a playback device 108.

The media server 104 comprises a transrater 110 that may change the bit rate or data density of the content, a packetizer 112 that prepares IP packets for transmission, and a data pacer 114 that sends the packets over the network 106.

The playback device 108 comprises a buffer 116 that receives and stores the incoming packets and a decoder/playback device 118 that displays the content for a user. The buffer 116 may be sized for a particular application so that a sufficient reserve of data may be stored to cover small variations in network throughput. A buffer statistics module 120 may monitor the buffer 116 and send the statistics back through the network 106 to the media server's congestion controller 124. The congestion controller 124 may vary the transrater 110 to change the bit density of the content stream or may also control the data pacer 114 to speed up or slow down the frequency of packets.

The embodiment 100 may be used for distributing data streams for video or audio data where the data are displayed in a paced sequence. The embodiment 100 may be a home video system where the content source 102 may be a cable television input or DVD player, and the decoder/playback device 118 may be a television monitor. In another example, the embodiment 100 may have the media server 104 connected to the internet network 106 to distribute streaming audio or video content to a user's computer system.

The embodiment 100 uses buffer statistics and network statistics 122 to adjust both the pacing of the packets and the bit rate or density of the data so that playback on the device 108 is of the highest quality possible. Variations in the network throughput may cause the media server 104 to reduce the density of the data as needed so that playback is continuous. The density of the data may be changed in several different manners, depending on the application. For an example of an audio file, the sampling rate may be reduced as a way of reducing the data density. In an example of a video file, selected frames may be dropped from the transmission, the resolution may be reduced, or other techniques may be used to reduce the data density.

When the data density is reduced, a data packet may contain a longer portion of the playback material. Thus, fewer packets or smaller packets are required to be transmitted across the network 106, and the communication between the media server 104 and the playback device 108 may use less bandwidth. The playback quality of the content may be reduced slightly or significantly, depending on how severe the data density is reduced.

Similarly, when the network 106 has increased bandwidth, the media server 104 may increase the bit rate or data density of the packets so that the user viewing experience is improved.

The network 106 may be shared by several devices, and in the case of the internet, millions of devices. Because the network 106 may not be dedicated to transferring content from the media server 104 to the playback device 106, the bandwidth and throughput of the network 106 may vary at times.

The network may vary in several different manners. In one case, another device may transmit a short burst of information over the network that may cause the throughput for the server/client communication to be hindered for a short period of time. In general, the buffer 116 at the playback device 108 may have enough stored data to tolerate such moderate fluctuations of the network 106.

In another case, another device may begin an extended transmission over the network 106 that may cause the data throughput of the network 106 to decrease. When the throughput decreases, it is possible that the server 104 cannot transmit enough data to the playback device 108 so that the playback device 108 can continuously playback the content. When the buffer 116 is depleted, the playback may suddenly stop, halt, or skip which is very annoying and distracting to a viewer or listener.

Because the congestion controller 124 monitors buffer statistics and network statistics 122, the data density may be decreased by controlling the transrater 110 when the network undergoes a period of low bandwidth or throughput. In general, small fluctuations of the network throughput may be handled by the buffer 116. When network congestion causes packets to be delayed and the buffer fullness drops below a threshold, the data pacer 114 may increase the rate of packet transmission when the network congestion eases until the buffer is replenished.

In some cases, the buffer fullness statistics may be used to indicate when each packet should be sent on an individual basis. In other cases, the buffer fullness statistics may be used to adjust the rate or frequency of nearly continuous packet transmissions.

The content source 102 may be any type of audio and/or video content. In some cases, the content source 102 may be live television or radio transmission, while in other cases the content source 102 may be a prerecorded program.

The transrater 110 may take the content input and change the bit rate or density of the content prior to sending the content to the device 108. The transrater 110 may be tailored for a specific type of data content. For example, audio signals may be sampled at different rates by the transrater 110. The sampling rate may be variable over a wide range and shifted up or down in small increments. In another example, the transrater 10 may change the bit rate or density of video signals by dropping individual video frames from a video sequence or by changing the resolution of the picture. In such an example, the transrater 110 may be able to change the bit rate or density in very coarse steps and may only have two or three options for bit rate settings.

The method by which the transrater 110 varies the bit rate or data density of the content corresponds with the ability of the playback device 108 to handle changes in bit rate of the incoming content. In some cases, the transrater 110 may embed bit rate information or other metadata into the content stream that is interpreted by the playback device 108 to handle a change in bit rate. In other cases, the transrater 110 may modify the content so that the playback device 108 does not sense a bit rate change and does not have to adapt the playback mechanism.

In the case of video content with audio, the transrater 110 may adjust the bit rate density of the resulting data stream by changing either the video or audio portion singly. For example, when the transrater 110 needs to lower the bit rate of video content with audio, the transrater 110 may leave the audio content intact but lower the bit rate by periodically removing individual frames from the video portion of the content. Another embodiment may lower the sampling rate of the audio content while leaving the video portion intact.

The packetizer 112 creates packets of data that are sent out over the network 106. In many cases, the packets may be Internet Protocol packets, but other packets may also be used. The packets may have a header with routing data as well as a data portion containing a small portion of the content data.

The data pacer 114 may send out the data packets at a regular interval to maintain the buffer 116 at a certain fullness level. In an equilibrium state, the data pacer 114 may send out as much data as being consumed by the playback device 108. When a packet is corrupted and needs to be resent by the media server 104, the buffer fullness may decrease. Over time, the buffer 116 may become depleted below a lower threshold and the data pacer 114 may have the pacing increased to build up the buffer 116. Once the buffer 116 reaches a high threshold, the data pacer 114 may be slowed down.

When the network 106 is saturated or nearly saturated, the data pacer 114 may not be able to increase the transmission of packets to build up the buffer 116. In such a case, the congestion controller 124 may exercise different options. In one option, the congestion controller 124 may determine that the network congestion is temporary and wait until the network bandwidth increases before increasing the rate of the data pacer 114. In another option, the congestion controller 124 may determine that the buffer is not sufficient to last through the network congestion. In such a case, the congestion controller 124 may decrease the bit rate from the transrater 110 so that the content may still be sent to the playback device 108, at the cost of diminished quality.

The network 106 may be any type of packetized network for electronic communication. A typical network 106 used in a home entertainment environment may use Ethernet using TCP/IP. Other networks may use any type of protocol, transport layer, and physical connection, including wired and wireless connections. In many cases, the network 106 may be the Internet or other wide area network.

The playback device 108 may be any device capable of receiving packetized content over a network and displaying the content for a user. In general, the playback device 108 may be receiving content and displaying the content in close to real time, with some delay built in because of the buffer 116. For example, the playback device 108 may be a computer attached to the internet that is receiving and displaying a bit stream audio or video program. In a home environment, the playback device 108 may be a television with a set top box, where the set top box receives, buffers, and decodes the incoming bit stream for display on a television.

The playback device 108 may be a single device, such as a personal computer, or may be multiple devices that function together, such as a set top box and television. In some cases, the playback device 108 may be a single purpose playback appliance, while in other cases, the playback device 108 may be a general purpose device that can be used for several other functions. Some embodiments of the playback device 108 may perform some or all functions in hardware, while other embodiments may be largely performed in software.

The buffer 116 may store data prior to display. The size and configuration of the buffer 116 may depend on the application. When attached to a network that is subject to large variation in throughput, the buffer 116 may be sized larger than when attached to a network with low variation. The size of the buffer 116 may be determined by the architecture of the playback device 108 and the amount and type of memory allocated to the buffer 116.

In general, the size of the buffer 116 reflects some tradeoffs in design. Larger buffers may be more tolerant of network variations, but may require a longer time to initially fill up. Thus, when a user selects a program to be displayed, the user may experience a delay before the program begins. A smaller buffer may allow the program to start quickly, but may be subject to unwanted skips, halts, or pauses during periods of network congestion.

The buffer statistics and network statistics 122 may include any information regarding the buffer 116 or the network 106. In many cases, the buffer statistics may include buffer fullness and the magnitude and direction of the rate of change of buffer fullness. In some cases, buffer fullness or another statistic may be transmitted at very specific intervals to the media server 104. The transmission of this information may be part of a handshake whereby the media server 104 can affirm that packets are being successfully transmitted to the playback device 108. In such a case, if the return information is repeatedly not received by the media server 104, the media server 104 may cease transmission of the data. The packets transmitted during the exchanges may be used to generate some network statistics.

The network statistics may include any characterization of the network that may be helpful in judging the network status. In some cases, a monitoring program or monitoring hardware may be used to observe network traffic and determine various statistics. In other cases, the time required for a packet to be transmitted from the media server 104 to the playback device 108 may be measured and used as a network statistic.

The network statistics may be a measure of the saturation, available bandwidth, throughput, or other proxy for the amount of network traffic. Various methods and devices may be used for determining a meaningful statistic. The network statistics may be used to detect when the network performance changes so that the media server 104 may increase or decrease the bit rate or density of the data sent to the playback device 108. In some cases, network throughput may be directly measured, while in other cases, another statistic or combination of statistics may be used as a proxy for network throughput or bandwidth.

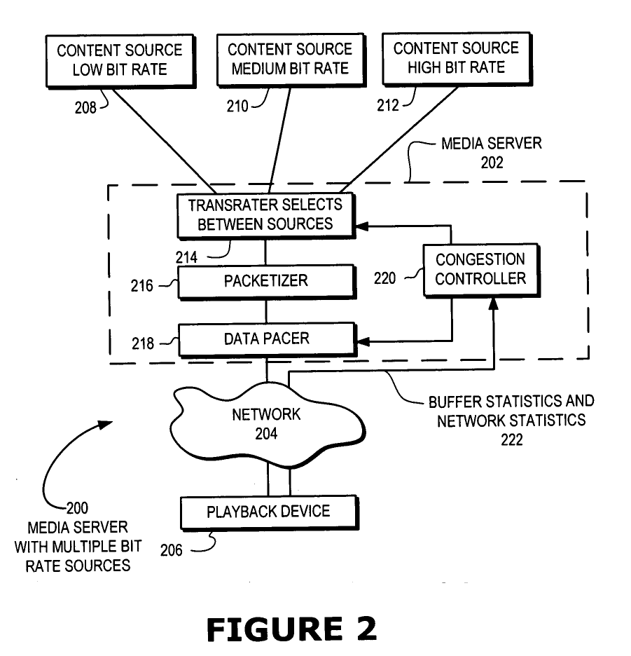

FIG. 2 illustrates an embodiment 200 showing a media server with multiple bit rate sources. The media server 202 sends audio or video media through the network 204 to a playback device 206.

The media server 202 has three content sources: a low bit rate source 208, a medium bit rate source 210, and a high bit rate source 212. The transrater 214 may select between the three sources to provide content to the packetizer 216, which feeds the data pacer 218. Data from the playback device 206 and network, in the form of buffer statistics and network statistics 222, are used by a congestion controller 220 to control both the data pacer 218 and the transrater 214.

The embodiment 200 is similar to the embodiment 100 with the exception that the transrater 214 may not perform much processing of the content. The transrater 214 may select between different versions of the content, each with a different bit rate or data density. When the congestion controller 220 determines that a higher or lower bit rate is required, the transrater 214 may begin feeding the appropriate content source.

In some embodiments, the content sources 208, 210, and 212 may have some type of indexing mechanism so that the transrater 214 may switch from one content stream to another while keeping the audio or video stream consistent. In a live broadcast scenario, two or more feeds of different densities may be switched back and forth by the transrater 214 easily when the feeds are presented synchronously. When the transrater 214 is required to switch between sources in a prerecorded scenario, the transrater 214 may determine an index in the current feed being presented, find a corresponding index in a different content source, and begin transmitting the video and/or audio sequence from the new content source.

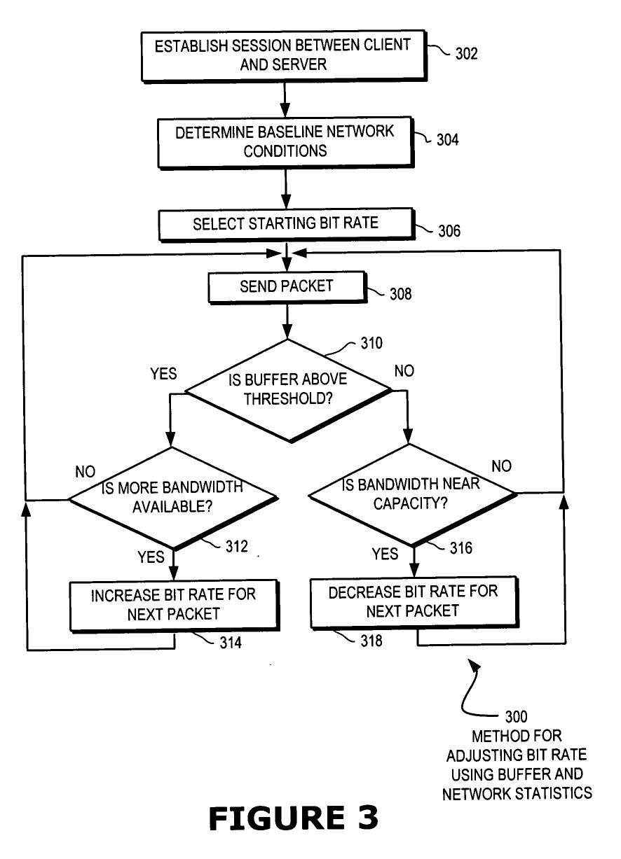

FIG. 3 illustrates an embodiment 300 showing a method for adjusting content bit rate using buffer and network statistics. A session is established between a client and server in block 302. Through the establishment of the session, a baseline network condition may be derived in block 304 and a starting bit rate or density is selected in block 306.

A packet is sent in block 308. Based on the buffer statistics from the playback device, if the buffer is above a threshold in block 310, and more bandwidth is available in block 312, the bit rate may be increased for the next packet in block 314. If the buffer is above the threshold in block 301 but there is no more bandwidth available in block 312, the bit rate remains the same. The process returns to block 308.

If the buffer is not above the threshold in block 310 and the network bandwidth is near capacity in block 316, the bit rate may be decreased for the next packet in block 318. If the buffer is not above the threshold in block 310 but there is more network bandwidth in block 316, the bit rate remains the same. The process returns to block 308.

The embodiment 300 is a simplified example of how buffer statistics and network statistics can be used in conjunction with each other to optimize the transmission of video and/or audio from a media server to a playback device. In general, when the buffer is full and the network has available bandwidth, the content bit rate may be increased. Similarly, when the buffer is not full and the network does not have much more bandwidth, the bit rate may be decreased.

The embodiment 300 is an illustration of a decision mechanism that may be executed for each packet transmitted over the network. In many cases, the decision mechanism may be executed over many packets, or the packet transmission may be assumed to be nearly continuous for the purposes of the decisions to increase or decrease the bit rate.

The starting bit rate in block 306 may be determined from the process of establishing a network session between the client and server. In other cases, a set of test packets may be exchanged between the client and server to test the network speed or determine other proxies for network congestion or data throughput. In still other cases, a specialized software routine or hardware device may measure various network statistics.

The starting bit rate in block 306 may be a predetermined value for a particular installation. In some cases, the starting bit rate may be a low density bit rate so that the audio and/or video program may be quickly started on the playback device, albeit at a lower density or quality, until the buffer is full. After filling the buffer in block 310, and if the network has enough bandwidth in block 312, the bit rate may be increased in block 314 and the quality of the playback will increase. Such a method minimizes a delay when the program starts with buffered systems having large buffers.

The buffer in the playback device may have different configurations. In many cases, the buffer may have a constant amount of memory dedicated to storing buffered data. When the bit rate is low, the buffered data may have a relatively long length of program stored for playback. When the bit rate is high, the same amount of memory may contain data that is played back much faster and thus hold much less of a program from a time standpoint. In such a scenario, the buffer is much more tolerant of network performance at low bit rates, but extremely more sensitive as the bit rate increases.

Other buffers may have a flexible amount of memory available for buffer storage. In such cases, a buffer may store a certain amount of time of playback data, regardless of the amount of data that must be stored. For example, the buffer may be constructed so that it stores a certain number of seconds'worth of playback data. With a low bit rate data feed, the buffer may store a small amount of data, but with a high bit rate data feed, the buffer may store a large amount of data. Such a configuration may be more tolerant of network fluctuations than with a constant memory size buffer, especially with high bit rate data in situations where a constant sized buffer may contain fewer seconds of information than a variable sized buffer.

The buffer threshold in block 310 may be different statistics for different buffer applications. In some scenarios, the buffer threshold may be a certain percentage of fullness. The fullness may be expressed in terms of allocated memory, playback time remaining in the buffer, or any other statistic that may be useful in a particular embodiment. In some situations, the threshold may be 100% or completely full. In other cases, the buffer may be substantially lower, such as 75%. A buffer threshold below 100% may prevent buffer overruns that could occur if the threshold were set to 100%. The buffer may be considered ‘full’ when the buffer is above the threshold value in block 310.

For various implementations, different thresholds or settings may be used to trigger the various decision blocks. In some implementations, one threshold may be used to trigger an increase in the bit rate, while a different threshold level may be used as a condition to lower the bit rate. The threshold settings for the buffer or network related decisions may vary depending on the type of installation, the network capabilities, the settings or capabilities of the media server and the playback device, various performance criteria, or the pure vagaries of the developers, installers, or users.

When the buffer is above a threshold value in block 310, a data pacer in the media server may be used to slow down the packet rate. Because the packet rate is slower, there may be sufficient bandwidth in the network in block 312 to increase the bit rate or density of the data packets in block 314. The bit rate is changed by using both the buffer and network statistics together.

The network statistics used in blocks 312 and 316 may depend on several variables relating to the network throughput. In a simple example, at the transfer of each individual packet, the network throughput may be estimated by the transfer time of a packet. These data may be sufficient in some cases to increase or decrease the bit rate. In other cases, the transfer time of data packets may be tracked over a period of time and various useful statistics may be generated to measure current network performance and thereby estimate future network performance.

For example, a moving average of packet send times may be kept to compare recent network performance to past network performance. If recent network performance is decreasing, a lower standard may be used in block 316 to decrease bit rate than if the network performance had been constant. In another example, the magnitude and rate of change of recent network performance may be used as criteria in blocks 312 and 316 to determine if the bit rate is to be changed.

In other embodiments, various time-value statistics of the buffer fullness may also be used to determine whether the bit rate should be changed. These statistics include moving averages, magnitude and rate of change, or other statistics relating to the fullness of the buffer may be used. In an example where these statistics may be used, a buffer fullness change dramatically downward may indicate that the user has performed some function on the playback device such as fast forwarding a video program, changing channels, or some other function. In this situation, the bit rate may be kept constant, reset to a lower default rate, or some other action may be taken rather than increasing the bit rate.

In another example, if the buffer fullness changes dramatically upward, the change may indicate that the user has paused playback. Even though the buffer is full and bandwidth is available, increasing the content bit rate may cause problems when the program is resumed. If the content bit rate were increased, the next packets may be much higher content bit rate or density and may fill the buffer with a large amount of data that would have a short amount of playback time. When playback resumes, the buffer may be emptied quickly and the system may struggle to keep up until the bit rate was lowered. By using time based statistics in addition to the raw fullness data for the buffer, the content bit rate may be kept constant during certain events or situations.

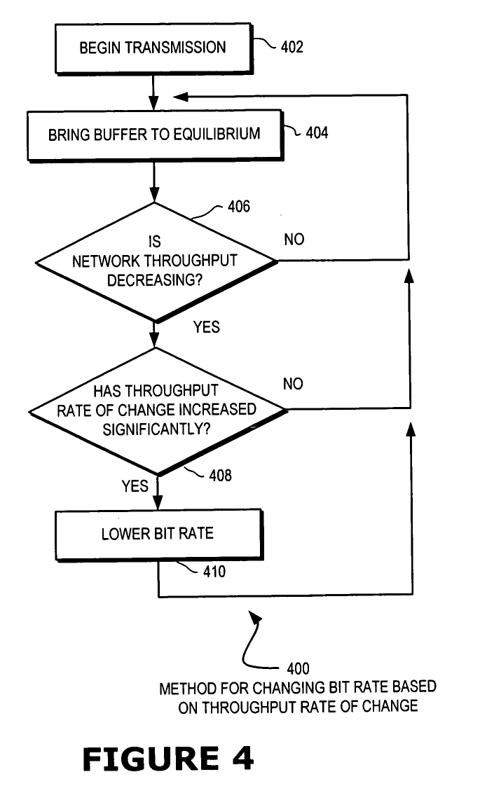

FIG. 4 is a flowchart illustration of an embodiment 400 showing a method for changing the bit rate based on throughput rate of change. The transmission begins in block 402. The buffer is brought to an equilibrium state in block 404. If the network throughput is not decreasing in block 406, no action is taken. If the network throughput is decreasing in block 406 and the throughput has decreased significantly in block 408, the bit rate is lowered in block 401 and the buffer is again brought to equilibrium in block 404.

The embodiment 400 is an example of managing an ongoing data transfer stream that may be considered continuous for the purposes of the decision to decrease the bit rate. The decision criteria in embodiment 400 may have a time value component that includes data from a history of network performance in order to change the bit rate or density of the data stream.

The decreasing network throughput in block 406 may be calculated by comparing the throughput at one time to a previous time. In other embodiments, the data may be smoothed by using moving averages, curve fitting, or other statistical tools. Data smoothing may be useful to avoid reacting to spurious noise or changes to the network performance that would otherwise be absorbed by the buffer.

Similarly, the rate of change of the network performance in block 408 may be observed using various statistical tools and methods. The rate of change of network performance may indicate whether a decrease in network performance is truly significant enough to warrant a change in bit rate. For example, if the network throughput is decreasing and the rate of change of the network throughput is high, substantial traffic on the network may be assumed and thus the bit rate may be lowered.

The embodiment 400 shows the criteria network throughput and rate of change of network throughput as binary functions. That is, for the bit rate to be changed, the network throughput may be decreasing at a certain magnitude and the rate of change may be above a certain magnitude for the bit rate to be changed. In other embodiments, the two factors, throughput and rate of change, may be combined in a formula to determine whether to change the bit rate. The formula may also estimate the amount of change required for the bit rate. Various combinations, functions, and formulas may be used to generate a value for making a determination as to whether to change the bit rate and how much the bit rate should be changed.

The embodiment 400 is an illustration of criteria used to make the decision to lower the bit rate. Similar decision mechanisms may be used to increase the bit rate. The specific criteria used to generate the decisions may vary for different implementations.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A device comprising:
a data input having an input data stream;
a network output connected to a playback device having an input buffer;
a network monitor adapted to monitor network statistics;
a device monitor adapted to monitor buffer statistics from said playback device;
a packetizer adapted to convert said input data stream into packets for transmission to said playback device;
a data pacer adapted to change the pacing of said packets;
a transrater adapted to change the bit rate of said packets; and
a controller adapted to control said data pacer and said transrater to increase and decrease said pacing of said packets and increase and decrease said bit rate of said packets based on said network statistics and said buffer statistics.

2. The device of claim 1 wherein said transrater is further adapted to select a version of said input data stream having a different bit rate.

3. The device of claim 1 wherein said transrater is further adapted to convert said input data stream to a different bit rate.

4. The device of claim 1 wherein said network statistics comprises rate of change of data throughput.

5. The device of claim 4 wherein said controller is further adapted to decrease said bit rate when said rate of change of said data throughput increases and said data throughput decreases.

6. The device of claim 1 wherein said buffer statistics comprises rate of change of buffer fullness.

7. The device of claim 1 wherein said controller is further adapted to increase said bit rate when said data throughput increases and the rate of change of buffer fullness of said input buffer is below a minimum threshold.

8. A system comprising:
a playback device having an input buffer;
a media server comprising:
a data input having an input data stream;
a network output connected to said playback device;
a network monitor adapted to monitor network statistics;
a device monitor adapted to monitor buffer statistics from said playback device;
a packetizer adapted to convert said input data stream into packets for transmission to said playback device;
a data pacer adapted to change the pacing of said packets;
a transrater adapted to change the bit rate of said packets; and
a controller adapted to control said data pacer and said transrater to increase and decrease said pacing of said packets and increase and decrease said bit rate of said packets based on said network statistics and said buffer statistics.

9. The system of claim 8 wherein said transrater is further adapted to select a version of said input data stream having a different bit rate.

10. The system of claim 8 wherein said transrater is further adapted to convert said input data stream to a different bit rate.

11. The system of claim 8 wherein said network statistics comprises rate of change of data throughput.

12. The system of claim 11 wherein said controller is further adapted to decrease said bit rate when said rate of change of said data throughput increases and said data throughput decreases.

13. The system of claim 8 wherein said buffer statistics comprises rate of change of buffer fullness.

14. The system of claim 8 wherein said controller is further adapted to increase said bit rate when said data throughput increases and the rate of change of buffer fullness of said input buffer is below a minimum threshold.

15. A method comprising:
receiving an input data stream;
monitoring network statistics;
monitoring buffer statistics from a playback device having a buffer;
packetizing said input data stream for transmission to said playback device, said packetizing being accomplished by a data pacer adapted to change the pacing of said packets, a transrater adapted to change the bit rate of said packets, and a controller adapted to control said data pacer and said transrater to increase and decrease said pacing of said packets and increase and decrease said bit rate of said packets based on said network statistics and said buffer statistics.

16. The method of claim 15 wherein said transrater is further adapted to select a version of said input data stream having a different bit rate.

17. The method of claim 15 wherein said transrater is further adapted to convert said input data stream to a different bit rate.

18. The method of claim 15 wherein said network statistics comprises rate of change of data throughput.

19. The method of claim 18 further comprising decreasing said bit rate when said rate of change of said data throughput increases and said data throughput decreases.

20. The method of claim 15 further comprising increasing said bit rate when said data throughput increases and the rate of change of buffer fullness of said input buffer is below a minimum threshold.
